(19) United States
(12) Patent Application Publication
(10) Pub. No.: US 2006/0242970 A1
(43) Pub. Date: Nov. 2, 2006

(54) Low-emission natural gas vaporization system

(75) Inventors: Chi-Cheng Yang, Sugar Land, TX (US); Zupeng Huang, Pearland, TX (US)

Correspondence Address: HELLER EHRMAN WHITE & MCAULIFFE LLP, 1717 RHODE ISLAND AVE, NW, WASHINGTON, DC, 20036-3001, US

(73) Assignee: Foster Wheeler USA Corporation, Clinton, NJ (US)

(21) Appl. No.: 11/115,350

(22) Filed: Apr. 27, 2005

(51) Int. Cl. F17C 9/02

(52) U.S. Cl. 62/50.2

(57) ABSTRACT

A low-emission gas vaporization system includes: a heat exchanger for cooling a medium used in a production process; a heat sink for eliminating heat; a vaporizer for changing liquid natural gas to gaseous natural gas; a cooling fluid supply path for providing cooled fluid to the heat exchanger from the heat sink; a cooling fluid return path for providing heated fluid to the heat sink from the heat exchanger; a heating fluid supply path for providing heated fluid to the vaporizer from the heat exchanger; and a heating fluid return path for providing cooled fluid to the heat exchanger from the vaporizer.

### BACKGROUND OF THE INVENTION

1. Field of the Invention

The present invention relates to natural gas vaporization, and more particularly, to low-emission natural gas vaporization system.

2. Discussion of the Related Art

Natural gas is usually shipped across the seas in a liquid state. The liquid natural gas (LNG) is vaporized at a receiving terminal for distribution via pipeline. LNG receiving terminals commonly use one of two types of LNG vaporizers. One of the types is the seawater open rack vaporizer (ORV) and the other type is the submerged combustion vaporizer (SCV).

An open rack vaporizer (ORV) uses ambient temperature seawater as the source of heat in an open, falling film type arrangement in which the seawater flows over tubes to vaporize LNG passing through the tubes. An ORV system consists of an aluminum alloy header and a heat conductor panel having a large number of finned heat exchanger tubes in a row like a curtain. An ORV contains several of these curtains, which are referred to as panels. The panels are grouped into independent panel groups. The panels are coated externally with zinc alloy to provide corrosion resistance against seawater.

Seawater is fed from an overhead distributor of an ORV such that the seawater falls over the panels. Then, the seawater is collected in a trough below the panels and routed for discharge from the ORV back to the sea. As the seawater flows over the outer surface of the long finned tube heat exchangers of the panels, heat is provide to the LNG flowing inside the panels so as to vaporize the LNG while cooling the seawater. The seawater temperature is preferably always above 8° C. so that the ORV can work efficiently and also be effectively controlled.

The surface of the finned heat exchanger tubes in an ORV must be kept clean to maintain efficient heat exchange. Water quality is an important factor in keeping the finned heat exchanger tubes clean. Typically, the seawater is chlorinated to protect the surface of the tube panel against bio-fouling and to prevent marine growth inside the piping of the ORV. The water should not contain solids exceeding a predetermined maximum diameter to assure uniform water flow without jamming of the solids between the water trough and the top of the tube panel. Further, sand and sludge deposits in the seawater water for an ORV should be negligible.

An ORV requires significant amounts of seawater. Thus, environmental studies are required that evaluate and assess the amount of underwater fish and plant life ingested by the intake system of an ORV. As discussed above, chlorination water treatment can be used to prevent marine growth inside the piping of the ORV. However residual chlorine content in discharged water can have a negative impact on the marine environment.

A submerged combustion vaporizer (SCV) burns natural gas as the heat source and requires electric power to run the combustion air blower. More particularly, the SCV evaporates LNG contained inside stainless steel tubes submerged in a water bath heated with a natural gas burner. In a baseload terminal SCV, the natural gas used as a fuel gas is burned in a large single burner rather than multiple smaller burners. A single large burner is more economical. Further, a single burner emits lower NOx and CO levels. The SCV is typically designed to utilize the low-pressure fuel gas derived from the boil off gases of the facility and/or the let-down gas from the send-out gas. The SCV may also use an extracted heavier fuel gas (C₂ plus) from the LNG at the LNG terminal.

The thermal capacity of the water bath is high in an SCV. Thus, it is possible to maintain a stable operation even for sudden start-ups/shutdowns and rapid load fluctuations. An SCV provides great flexibility for quick start-up after shutdowns and the ability to quickly respond to changing demand requirements.

The hot flue gases from the burner are sparged into the water bath where the LNG vaporization coils are located to further economically heat the water bath. Thus, the bath water becomes acidic as the combustion products are absorbed in it. Alkaline chemicals (e.g. dilute caustic, sodium carbonate and sodium bicarbonate) must be added to the bath water to control pH value, and resulting excess combustion water must be neutralized before discharge into the environment.

As discussed above, both the SCV and ORV have emissions that impact the environment. Although treatment methods have been developed for both systems to minimize environmental impact, these treatment methods add cost. Accordingly, a more cost effective method of reducing environmental impact is needed.

### SUMMARY OF THE INVENTION

Accordingly, the present invention is directed to a liquid natural gas vaporization system that substantially obviates one or more of the problems due to limitations and disadvantages of the related art.

An object of the present invention is to reduce the environmental impact of a liquid natural gas vaporization system.

Another object of the present invention is to provide a heat source for a liquid natural gas vaporization system.

Another object of the present invention is to provide a liquid natural gas vaporization system as a cooling source for a heat exchanger that cools a medium used in a production system.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a low-emission vaporization system includes: a heat exchanger for cooling a medium used in a production process; a heat sink for eliminating heat; a vaporizer for changing liquid natural gas to gaseous natural gas; a cooling fluid supply path for providing cooled fluid to the heat exchanger from the heat sink; a cooling fluid return path for providing heated fluid to the heat sink from the heat exchanger; a heating fluid supply path for providing heated fluid to the vaporizer from the heat exchanger; and a heating fluid return path for providing cooled fluid to the heat exchanger from the vaporizer.

In another aspect, a low-emission gas vaporization system includes: a production process using a medium; a heat exchanger that receives an input medium from the production process and sends an output medium back into the production process for reuse in the production process; a heat sink for eliminating heat; a vaporizer for changing liquid natural gas to a gaseous natural gas; a cooling fluid supply path for providing cooled fluid to the heat exchanger from the heat sink; a cooling fluid return path for providing heated fluid to the heat sink from the heat exchanger; a heating fluid supply path for providing heated fluid to the vaporizer from the heat exchanger; and a heating fluid return path for providing cooled fluid to the heat exchanger from the vaporizer.

In yet another aspect, a low-emission natural gas vaporization system includes: a power generation process using water to drive a steam turbine generator; a condenser for condensing steam output from the steam turbine generator; a heat sink for eliminating heat; a vaporizer for changing liquid natural gas to gaseous natural gas; a cooling fluid supply path for providing cooled fluid to the condenser from the heat sink; a cooling fluid return path for providing heated fluid to the heat sink from the condenser; a heating fluid supply path for providing heated fluid to the vaporizer from the condenser; and a heating fluid return path for providing cooled fluid to the condenser from the vaporizer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of the present invention.

FIG. 2 is representative schematic for an exemplary embodiment of a low-emission natural gas vaporization system.

### DETAILED DESCRIPTION OF THE PREFERRED EMBODIMENTS

Reference will now be made in detail to the preferred embodiments of the present invention, examples of which are illustrated in the accompanying drawings.

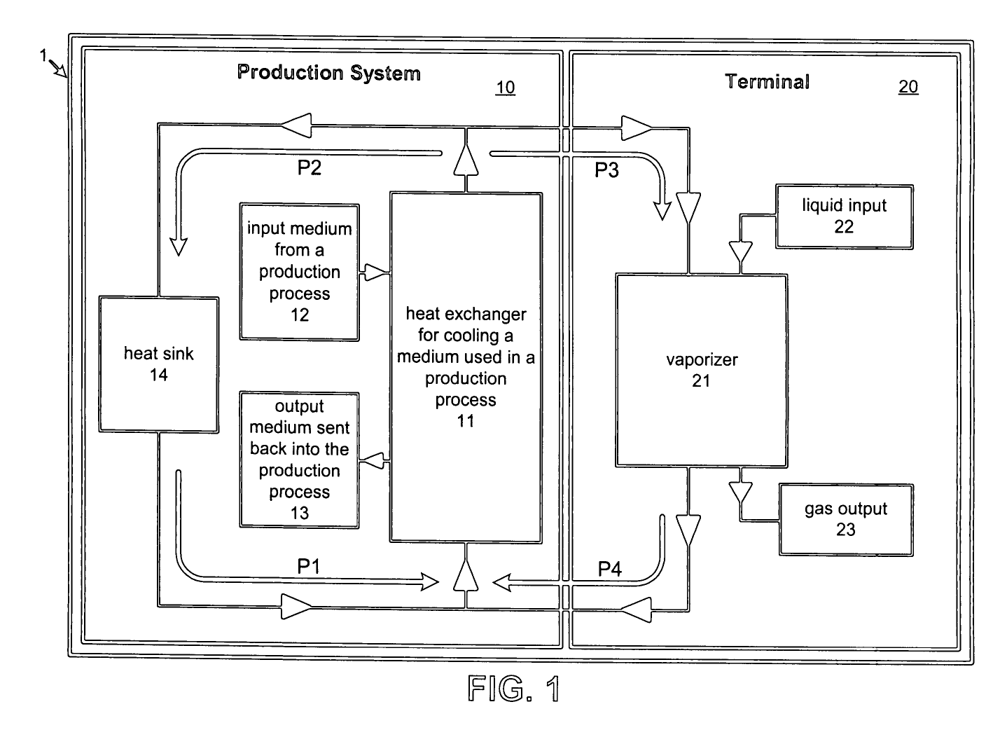

Exemplary embodiments of the present invention reduce emission from a vaporization terminal by using waste heat from a production process, such as a power plant or other industrial production process. FIG. 1 is a block diagram of the present invention. As shown in FIG. 1, a system 1 for gas vaporization with low emissions includes a production system 10 and a terminal 20.

The production system 10 includes a heat exchanger 11 for cooling a medium used in a production process of the production system. More specifically, the heat exchanger 11 receives an input medium 12 from a production process, cools the medium used in the production process, and sends an output medium 13 back into the production process such that the medium can be reused by the production process. The input medium 12 has a higher temperature than the output medium 13. The production system 10 also includes a heat sink 14 for eliminating heat. The heat exchanger 11 cools the medium used in the production process by receiving cooled fluid via a cooling fluid supply path P1, removing heat from the medium used in the production process, and providing heated fluid back to the heat sink 14 via a cooling fluid return path P2.

The terminal 20 includes a vaporizer 21 for changing a liquid to a gas. More specifically, the vaporizer 21 receives a liquid input 22 and heats the liquid to produce a gas output 23. The vaporizer 21 evaporates the liquid by receiving heated fluid from the heat exchanger 111 via a heating fluid supply path P3 that adds heat to the liquid and provides a cooled fluid back to the heat exchanger 11 via a heating fluid return path P4.

The production process can be power generation in a power plant in which the medium of the production process is the water in a thermal cycle used to drive steam turbine generators. In another example, the production system can be a chemical plant or refinery that uses cooling water. In yet another example, the production system can be a steel fabrication process in a steel mill in which the medium is a coolant used to quench steel. In general, a production process can be any industrial process that uses a medium from which heat can be removed.

The liquid, which is vaporized, is liquid natural gas. The heat sink 14 can be, for example, a cooling tower or other types of large scale heat sinks. The vaporizer can be an ORV, which just uses the heated fluid from the heat exchanger to vaporize natural gas. In the alternative, the vaporizer can be a SCV that uses a flow of heated fluid through the bath of the SCV along with a burner or without burner. In other words, the vaporizer can be a supplemented SCV, which uses both the heated fluid and a burner as heat sources for vaporization. However, the SCV can receive the heated fluid without the burner. In yet other alternatives, other types of shell and tube type vaporizers in which heat is transferred through a fluid can also be used.

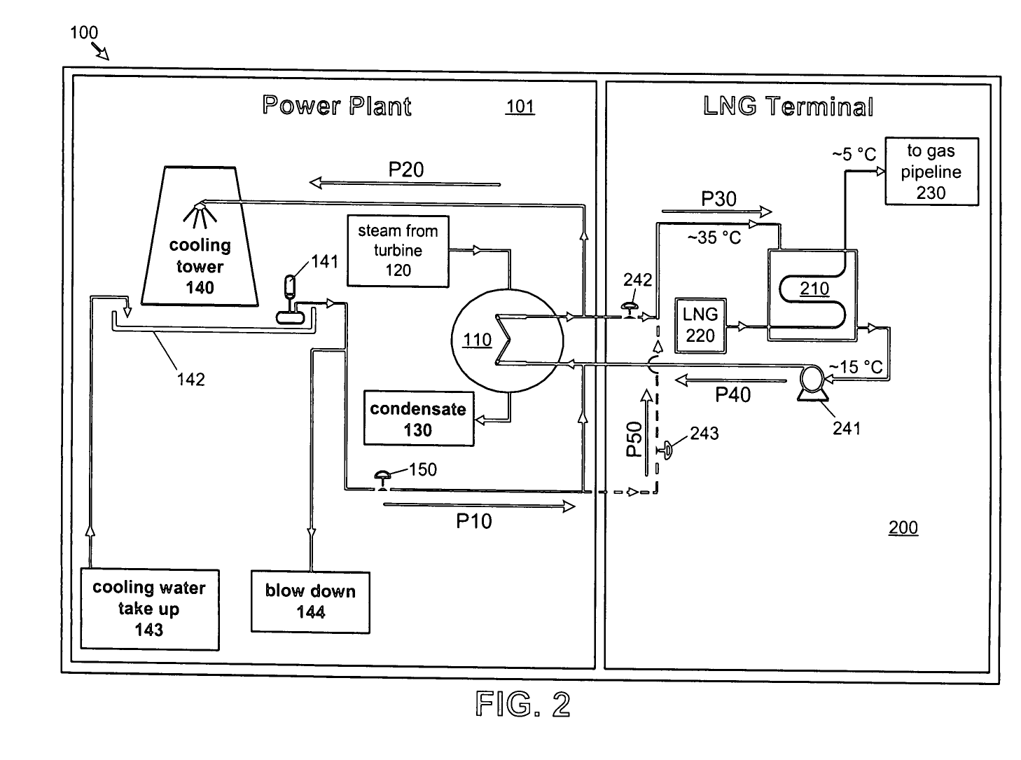

FIG. 2 is representative schematic for an exemplary embodiment of a low-emission gas vaporization system. As shown in FIG. 2, a system 100 for gas vaporization with low emissions includes a power plant system 101 and a liquid natural gas (LNG) terminal 200. The power plant uses a water based medium, such as water or a water/glycol mixture to drive a steam turbine power generator (not shown).

The power plant includes a condenser 110 for cooling steam 120 from the steam turbine power generator. More specifically, the condenser 110 receives exhaust steam 120 from the steam turbine power generator, cools the steam, and sends condensate 130 back into a thermal cycle for driving the steam turbine generators. The power plant 101 also includes a cooling tower 140 for eliminating heat. The condenser 110 cools the steam exhausted from the steam turbine power generator by receiving cooled water via a cooling water supply path P10, removing heat from the steam exhausted from the steam turbine power generator, and providing heated water back to the cooling tower 140 via a cooling water return path P20.

The liquid natural gas terminal 200 includes a vaporizer 210 for changing liquid natural gas into gaseous natural gas. More specifically, the vaporizer 210 receives a liquid natural gas 220 and heats the liquid natural gas to produce a gaseous natural gas 230. The vaporizer 210 evaporates the liquid natural gas by receiving heated fluid from the condenser 110 via a heating water supply path P30 to add heat to the liquid natural gas and provides cooled water back to the condenser 110 via a heating water return path P40.

As shown in FIG. 2, cooled water is moved from the cooling tower with a cooling tower pump 141. The cooling water supply path P10 includes a cooling water supply valve for controlling the supply of cooled water from the cooling tower 140. If the supply of water is insufficient in the system 101, additional water is provided through a cooling water take-up 143, such as by pumping water into the system 101 from a reservoir. If there is too much water in the system 101, the excess water is removed by blow down, such as by pumping the excess water into an evaporation pond. The heating water supply path P30 includes a heating water supply valve for controlling the flow of heated water from the condenser 110 to the vaporizer 210. In the alternative, as shown by the dashed elements in FIG. 2, a cooling water mixing supply path P50 can be connected between the cooling water supply path P10 and the heating water supply path P30. The cooling water mixing supply valve 243 can control how much cooled water from the cooling tower is mixed with heated water from the condenser. The mixture of the cooled water and heated water is provided to the heating water supply path P30.

The cooling tower duty can be reduced by diverting heated water to LNG vaporization. For example, about 536 million BTU/hr cooling water duty at about 39° C. steam temperature level is required for the GE 9FA Unit Combined Cycle system with 390.8 MW power export. This heat duty can be used to vaporize about 950 million std. ft³/day, (or 6.9 million tonnes per annum) LNG. About 30,000 gallons/minute of water is needed to pump around the system between the power plant and the LNG terminal based on a 20° C. water temperature drop utilized in the LNG vaporizers. Further, the power plant efficiency is improved as the steam turbine exhaust steam is condensed at a lower pressure because of using colder cooling water. For example, if the condensing temperature is lowered by 10° C., the steam turbine power export will be increased by 1.3 MW.

The LNG vaporization system described above reclaims waste heat from either a power plant or other industrial facilities to the SCV. Further, the LNG vaporization system described above can be used such that an ORV will have significantly less seawater intake/outtake. Furthermore, thermal efficiency of a power plant can be improved by reclaiming waste cold from an LNG vaporization terminal.

It will be apparent to those skilled in the art that various modifications and variations can be made in the low-emission natural gas vaporization system of the present invention without departing from the spirit or scope of the invention. Thus, it is intended that the present invention cover the modifications and variations of this invention provided they come within the scope of the appended claims and their equivalents.

What is claimed is:

1. A low-emission natural gas vaporization system, comprising:
a heat exchanger for cooling a medium used in a production process;
a heat sink for eliminating heat;
a vaporizer for changing liquid natural gas to gaseous natural gas;
a cooling fluid supply path for providing cooled fluid to the heat exchanger from the heat sink;
a cooling fluid return path for providing heated fluid to the heat sink from the heat exchanger;
a heating fluid supply path for providing heated fluid to the vaporizer from the heat exchanger; and
a heating fluid return path for providing cooled fluid to the heat exchanger from the vaporizer.

2. The system of claim 1, wherein the heat exchanger receives an input medium from the production process and sends an output medium back into the production process for reuse in the production process.

3. The system of claim 1, wherein the production process is power generation in a power plant and the heat sink is the steam condenser of the power plant.

4. The system of claim 1, wherein the heat sink is a cooling tower.

5. The system of claim 1, wherein the medium is a mixture of glycol and water.

6. The system of claim 1, wherein the vaporizer is an open rack vaporizer.

7. The system of claim 1, wherein the vaporizer receives a mixture of cooled fluid from the heat sink and heated fluid from the heat exchanger.

8. The system of claim 1, wherein the vaporizer is a submerged combustion vaporizer.

9. A low-emission gas vaporization system, comprising:
a production process using a medium;
a heat exchanger that receives an input medium from the production process and sends an output medium back into the production process for reuse in the production process;
a heat sink for eliminating heat;
a vaporizer for changing liquid natural gas to gaseous natural gas;
a cooling fluid supply path for providing cooled fluid to the heat exchanger from the heat sink;
a cooling fluid return path for providing heated fluid to the heat sink from the heat exchanger;
a heating fluid supply path for providing heated fluid to the vaporizer from the heat exchanger; and
a heating fluid return path for providing cooled fluid to the heat exchanger from the vaporizer.

10. The system of claim 9, wherein the production process is power generation in a power plant and the heat sink is a steam condenser in the power plant.

11. The system of claim 9, wherein the heat sink is a cooling tower.

12. The system of claim 9, wherein the medium is a mixture of glycol and water.

13. The system of claim 9, wherein the vaporizer is an open rack vaporizer.

14. The system of claim 9, wherein the vaporizer receives a mixture of cooled fluid from the heat sink and heated fluid from the heat exchanger.

15. A low-emission natural gas vaporization system, comprising:
a power generation process using water to drive a steam turbine generator;
a condenser for condensing steam output from the steam turbine generator;
a heat sink for eliminating heat;
a vaporizer for changing liquid natural gas to gaseous natural gas;
a cooling fluid supply path for providing cooled fluid to the condenser from the heat sink;
a cooling fluid return path for providing heated fluid to the heat sink from the condenser;
a heating fluid supply path for providing heated fluid to the vaporizer from the condenser; and
a heating fluid return path for providing cooled fluid to the condenser from the vaporizer.

16. The system according to claim 15, further comprising:
a cooling fluid supply path for providing cooled fluid to the condenser from the heat sink; and
a cooling fluid return path for providing heated fluid to the heat sink from the condenser.

17. The system of claim 15, wherein the heat sink is a cooling tower.

18. The system of claim 15, wherein the vaporizer is an open rack vaporizer.

19. The system of claim 15, wherein the vaporizer receives a mixture of cooled fluid from the heat sink and heated fluid from the condenser.

20. The system of claim 15, wherein the vaporizer is a submerged combustion vaporizer.
